(19) United States
(12) Patent Application Publication
(10) Pub. No.: US 2002/0066028 A1
(43) Pub. Date: May 30, 2002

(54) Computer virus avoidance system and mechanism using website

(76) Inventors: Christopher Michael Welborn, Davis, CA (US); Kimberly Joyce Welborn, Davis, CA (US)

Correspondence Address: CHRISTOPHER MICHAEL WELBORN, 331 SANDPIPER DRIVE, DAVIS, CA, 95616, US

(21) Appl. No.: 09/728,727

(22) Filed: Nov. 30, 2000

(51) Int. Cl. G06F 11/30; G06F 15/16

(52) U.S. Cl. 713/201; 709/206

(57) ABSTRACT

Nearly all computer viruses require an action by a computer user to infect and spread. The key is to educate users not to open e-mail attachments that might carry computer viruses. The key is behavior modification, as education is not sufficient. Effective behavior modification must have a means to reinforce the change and to measure how widespread the change is in a population. The invention is used to reinforce and measure the change in user behavior. The invention sends an e-mail with an attachment to e-mail users and creates a list of all users that open the attachment. The user is sent an e-mail with an attachment that looks similar to attachments that contain computer viruses. If the attachment is opened, an e-mail is sent to the e-mail address of a specific web-page on the internet's World Wide Web. This web-page collects all of the e-mail from users who have not changed behavior and need additional education or management attention.

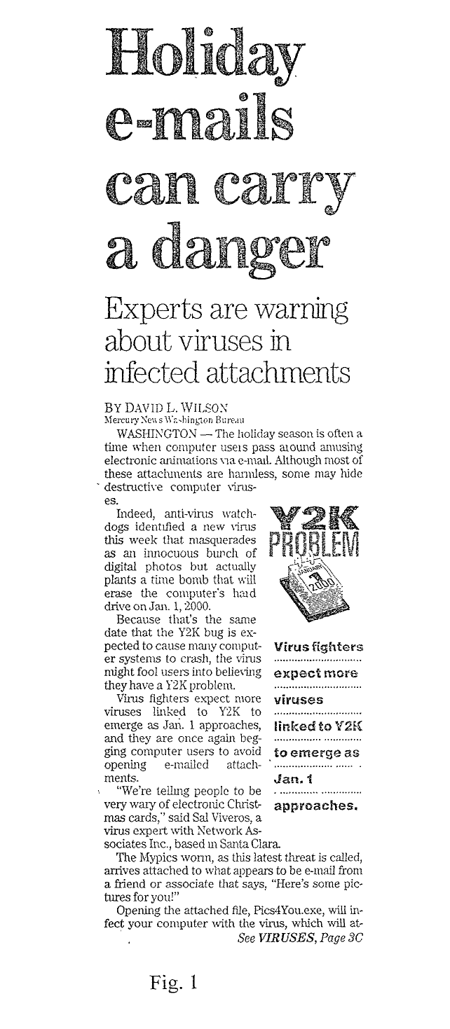

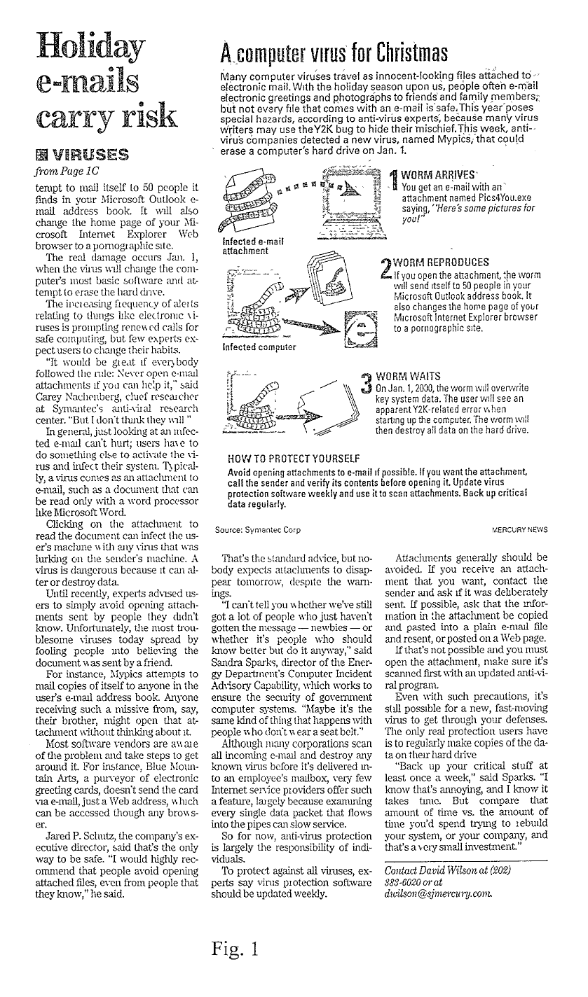

### BACKGROUND OF THE INVENTION

This invention relates to a computer system that aids in the behavior modification of computer users who unknowingly and innocently spread computer viruses, specifically by teaching computer users to avoid computer viruses with the use of mock computer viruses and feedback measurements.

The Battle Against Computer Viruses:

Computer viruses pose significant threats to computer systems. Viruses cause loss of data, destroy computer hardware, create negative impacts to computer networks and systems, and disrupt business, government, and personal affairs. In the battle against computer viruses, an entire industry was created to develop and sell “anti-virus” software to detect, remove, and insulate computers from viruses. Numerous patents have been granted to achieve these same goals. Examples of corporations within the anti-virus industry are Symantec and Network Associates. Currently, the control of viruses is dependent upon companies such as these to identify characteristics of viruses, write anti-virus software to detect viruses when encountered, and insulate computers from viruses. However, viruses are created faster than anti-virus software, and anti-virus software cannot always prevent outbreaks of virus infections. It is desirable to avoid the negative impacts of virus infections without reliance on software that needs to continually adapt to detect new specific viruses.

What Are Computer Viruses?

A computer virus is a program that invades computer host systems. Once inside a host system, the virus may replicate and create copies of itself. The virus may also cause damage to the host system. Viral programs can damage host systems by using the host file system to overwrite data in host systems, or over-write data stored in networks attached to host systems, or create numerous other disruptions or damage. In addition to damaging the host system, the virus may perpetuate itself by transmitting replicated copies to other computer systems. Most computer viruses use e-mail systems to transmit the replicated copies to other computer systems. By transmitting replicated copies of itself to other computer systems, the virus invades new host systems and continues the life-cycle of viral replication, host system damage, and transmission of duplicate virus programs.

How Computer Users Spread Viruses:

E-mail systems alone cannot activate viral programs within host systems. Viral programs require activation by computer users, and therefore viral programs are sent as file attachments to e-mail messages. The creators of the viral programs rely on computer users to open the infected file attachments. The viral programs activate when users open infected attached files. The term “open” means the user starts the program in the attachment or starts a program associated with the attachment. In Microsoft Windows and NT operating systems, data files are named in a two part format of the form xxxxxxxx.yyy, where the “.” separates the user given name, “xxxxxxxx”, from the extension, “yyy”. The operating system uses the extension, “yyy”, to select how the data file is to be treated when opened. For example if the extension is “exe”, then the operating system treats the data file as an executable program and passes control to it when opened. Or, if the extension is “doc”, the operating system associates the document with the Microsoft Word program, loads the Microsoft Word program, and passes control to the Microsoft Word program with the data file as an input file.

What Are Viral Infected E-Mail Attachments?

Viral infected e-mail attachments are of two types: 1) programs that execute when opened or 2) “macros” that execute when data files are opened as documents in other programs such as Microsoft Word. A macro is a program that is written in a language specific to another program such as Microsoft Word. Macros are used to automate sets of “user actions”. Examples of macro “user actions” are the ability to open and write data files, and to send e-mail messages with attachments to recipients in the users' e-mail directories. Viral macros may use the previously described user actions and other functions to send replicated copies of themselves as attachments to other e-mail users. The infected attachments may cause damage to data in the host system or to data in a network that is attached to the host system.

Life-Cycle of Computer Viruses:

The key to life or the goal of viruses is to replicate and transmit copies of itself to other computer systems. There are viral programs that can access the computer users' e-mail directory and the computer users' e-mail folders. This access allows the virus to send additional replicated viral attachments to associates of the user. The viral e-mail messages appear to originate from someone the recipient knows and trusts, when in fact the virus sends the e-mail message itself. The unsuspecting recipient opens the infected files due to the mistaken belief that the file is virus-free merely because the e-mail was sent from a familiar e-mail address. The opened and activated virus file repeats its cycle, and the virus succeeds in its continuous spread to other computer systems.

What Is Being Done?

Anti-virus companies such as Symantec and Network Associates attempt to stop viruses with the detection, removal, and insulation of computer viruses. Additionally, software creators of e-mail systems attempt to curb the spread of viruses by building features into e-mail programs that attempt to prevent the opening of viral attachments. For example, Microsoft Corporation added capabilities to recent releases of Outlook and Exchange e-mail programs that makes opening attachments with executable programs a two-step process. In the Microsoft Outlook email program, an attachment to an e-mail appears as an icon in the body of the e-mail. The file name appears as text in the icon. The user “opens” the attachment by double clicking on the icon. The first step consists of a warning message that is displayed when the icon is double-clicked. The user must perform a second action to actually open the file. Consistent with this, recent releases of Microsoft Word and Excel have a similar two-step document opening process if there is a macro in the document. First the user is warned that there is a macro in the document. The second step requires the user to choose to not open the document, disable the macro and open the document, or open the document with an active macro. In spite of these virus avoidance measures, computer users continue to open attachments with viruses, which in turn harms their systems, and sends replicated viral copies to other unsuspecting computer systems. An article written by David L. Wilson and published in the Dec. 4, 1999 edition of the San Jose Mercury News is included as background information on how computer viruses damage, replicate and spread.

### BRIEF SUMMARY OF THE INVENTION

The dangerous computer virus phenomenon cannot be neutralized solely by the use of software programs that detect and remove computer viruses, or by functions within e-mail programs that warn against opening potentially harmful files and attachments. Nearly all computer viruses require action by computer users in order for the viruses to infect and spread. Therefore computer users must change their behavior to stop viruses. Our invention is a tool that teaches computer users to avoid computer viruses with the use of mock computer viruses. The invention can aid, test, and reinforce behavior changes. The invention can also measure the effectiveness of behavior change in an organization or e-mail population by collecting and analyzing feedback measurements.

### BRIEF DESCRIPTION OF THE SEVERAL VIEWS OF THE DRAWING

An article written by David L. Wilson and published in the Dec. 4, 1999 edition of the San Jose Mercury News is included as background information on how computer viruses damage, replicate and spread. The article demonstrates that attempts are made by the mass media to educate computer users to avoid computer viruses. Despite the widespread information available to users on how to avoid computer viruses, the advice is left unheeded and the viruses continue to damage, replicate, and spread. The article is labeled as Drawing 1.

### DETAILED DESCRIPTION OF THE INVENTION

Computer Users Spread Computer Viruses:

Nearly all computer viruses require action by computer users for the viruses to infect and spread. The key to controlling viruses is to educate users not to open file attachments that might carry viruses. Education about how to avoid computer viruses is similar to education about how to avoid incurable human viral diseases. For example, in some cases of human disease, there are human behaviors that can eliminate or minimize exposure to infectious disease. Computer viruses are similar in that behavior modification on the part of computer users can greatly eliminate or minimize exposure to computer viruses. However, education alone is an ineffective tool to stopping viruses. There are many widely published writings and documents, such as the San Jose Mercury News article, that warn of the danger of opening computer viral attachments yet many people continue to open infectious attachments. Effective behavior modification must have a means to reinforce the change, and to measure how widespread the change is in a population.

Changing Human Behavior is the Key to Conquering Computer Viruses:

In general, most computer users do not need to send executable programs as attachments or documents with macros to other e-mail users. One behavior change is that a user should not send executable programs or documents with macros unless absolutely necessary. If it is necessary to send such attachments, the sender needs to communicate to the recipient to expect specific attachments. The second, and most important, behavior change is that a user should not open an attachment that is an executable program or a document with a macro unless there is specific knowledge that the attachment is safe to open. The third behavior change is that a user should inform their information services staff if they receive an e-mail attachment that appears to contain a computer virus. This last behavior provides early warning of new computer viruses, and allows companies such as Symantec and Network Associates to update their anti-virus software detection programs before the virus becomes widespread.

How Behavior Changes can be Made, Measured and Tracked:

Our invention tests, reinforces, and measures the changes in computer user behavior in regards to viral attachments, or attachments that may carry viruses. The invention sends e-mail messages with attachments to e-mail users. The attachments look similar to attachments that carry computer viruses. The invention creates a list of all users that open the attachment. If the attachment is opened, an e-mail is sent to the e-mail address of a specific internet web server containing a relational database. The e-mail contains identifying information including but not limited to the e-mail address of the sender and what time it was sent. This identifying information is stored in the relational database. This specific internet web server collects and stores all of the identifying information from users who have not changed their behavior and need additional education or management attention. Additionally, a message within the attachment is displayed to the e-mail user informing them that they opened a file that could have contained an infected virus. The e-mail user may also receive a separate e-mail message informing them again that they opened a file that could have contained an infected virus.

It is possible to test, measure, and track behavioral changes of an entire e-mail user population of a corporation for example, or randomly sample a small portion of an e-mail community. E-mail systems such as Microsoft Outlook have the ability to track when a user receives an e-mail message, opens an e-mail message, and deletes an e-mail message. However these e-mail tracking functions only apply to the e-mail messages and not to the attachments. The behaviors of e-mail users, such as deletion of the invention e-mail, can be tracked and measured. In addition, for behavior reinforcement, the attachment can display a message that warns the user that they have opened an attachment that could have been a computer virus. The attachment can also act very similar to a computer virus and replicate itself and transmit copies to other e-mail addresses (secondary e-mail addresses). Secondary e-mail addresses can be gathered from the original user's personal e-mail directories. It will appear to the secondary email recipients that the email attachments originated from people that the secondary recipients might know, when in fact the e-mail messages and attachments originated from the invented viruses. These actions are similar to the behavior of real computer viruses and they will test an organization for safe computer behavior. To limit the impact of the computer virus replication process, the invented virus may contain a counter that changes with each replication cycle. The replication process can cease after a specified number of cycles.

The Concept and Design of the Invented Virus:

The invention is basically a benign computer virus, and therefore must be designed to pass undetected by anti-virus software and be attractive for e-mail users to open. Since anti-virus software is continuously updated and user behavior will become more sophisticated, the invention must also be continuously updated to mimic harmful “wild” computer viruses.

The basic elements of the invented benign virus can be implemented as executable programs written in C++, Visual Basic, or a number of programming languages that contain programming functions that use Mail Application Programming Interface, MAPI. The invention uses MAPI to send feedback e-mail information to a specific e-mail address of a specific web-page on the internet's World Wide Web. This web-page is used by persons who will monitor, measure, and track computer user behavior (i.e. the persons who will perform the “tracking function”—for example an Information Systems administrator). The invented program is sent as an attachment to the e-mail users. The invention can also be implemented as a Microsoft Word macro in a Word document using macros such as “File”, “Send to”, or “Mail Recipient” functions. The macros can send e-mail feedback to the specific web-page which is used by persons performing the “tracking function”.

The design of the benign virus can be crafted from virulent viruses to mimic their appearance and replication capabilities. The virulent virus would be modified to send the e-mail information to the specific web-page performing the tracking function, and the destructive functions would be deleted. The virulent virus may also need to be modified to circumvent anti-virus programs. The resulting benign virus is sent as an e-mail attachment to the test population. All of the users who open the attachment will send an e-mail to the e-mail address of the specific web-page used by the persons performing the “tracking function”. The specific web-site can be used to generate a list of users who need additional attention. The steps of creating the e-mail user list to be tested, sending the e-mails, and creating the list of e-mail users may be done as manual steps or automated as a program using the MAPI functions.

One key element in the battle against computer viruses is changing user behavior to prevent opening infected e-mail attachments. This invention aids in reinforcing and measuring changes in user behavior.

We claim:

1. A computer virus avoidance system that sends an e-mail with an attachment to e-mail users, creates a list of e-mail users that open the attachment, and the list is accessible as a page on the World Wide Web.

2. The computer virus avoidance system of claim 1, wherein the attachment displays a message to the user when the attachment is opened.

3. The computer virus avoidance system of claim 1, wherein an e-mail message is sent to users that open the attachment.

4. The computer virus avoidance system of claim 1, wherein the attachment transmits replications of itself to other e-mail users.

5. The computer virus avoidance system of claim 4, wherein the number of replication and transmission cycles is limited.

6. A computer virus avoidance system and an e-mail system, comprising: a means for sending an e-mail with an attachment to an e-mail address, and a means to send an e-mail to a specific e-mail address of a web-page on the internet's World Wide Web when the attachment is opened

7. The computer virus avoidance system of claim 6, wherein the attachment displays a message to the user when the attachment is opened.

8. The computer virus avoidance system of claim 6, wherein an e-mail message is sent to users that open the attachment.

9. The computer virus avoidance system of claim 6, wherein the specific e-mail address of the web-page creates a list of e-mail users that opened the attachment.

10. The computer virus avoidance system of claim 6, wherein the attachment contains a means to send a replica of itself to another e-mail address.

11. The computer virus avoidance system of claim 10, wherein the number of times that the attachment replication process is limited.

12. A computer virus avoidance system in a computer network and a system for sending an email wherein an e-mail is sent to an e-mail address, and the e-mail has an attachment that sends an e-mail to a specific web-page on the internet's World Wide Web when the attachment is opened.

13. The computer virus avoidance system of claim 12, wherein the attachment displays a warning message to the user when the attachment is opened.

14. The computer virus avoidance system of claim 12, wherein an e-mail message is sent to users that open the attachment.

15. The computer virus avoidance system of claim 12, wherein the specific e-mail address is that of a web-page on the internet's World Wide Web that creates a list of e-mail addresses that have sent it messages.

17. The computer virus avoidance system of claim 12, wherein the attachment sends a replica of itself to another e-mail addresses.

18. The computer virus avoidance system of claim 17, wherein the number of replication cycles is limited.
